(19) United States
(12) Patent Application Publication
(10) Pub. No.: US 2006/0289233 A1
(43) Pub. Date: Dec. 28, 2006

(54) Roofing safety system and method

(76) Inventor: Brian J. Flaherty, Alamo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/159,869

(22) Filed: Jun. 23, 2005

(51) Int. Cl. A62B 35/00

(52) U.S. Cl. 182/45; 182/3

(57) ABSTRACT

A roofing safety system comprises a support assembly adapted to be secured to the roof of a building. The support assembly comprises a central anchor shaft having an upper portion and a lower portion. The support assembly comprises a plurality of struts, each strut having an upper portion and a lower portion, the upper portions of the struts configured to be pivotally coupled to the upper portion of the central anchor shaft. The support assembly comprises a central extension shaft having an upper portion and a lower portion, the lower portion of the central extension shaft configured to be coupled to the upper portion of the central anchor shaft. The support assembly comprises at least one extension arm configured to be rotatably coupled to the upper portion of the extension shaft. The roofing safety system comprises at least one self-retracting lifeline configured to be coupled to the extension arm of the support assembly. The roofing safety system comprises at least one worker restraint configured to be coupled to the self-retracting lifeline.

### BACKGROUND OF THE INVENTION

1. Field of the Invention

This application relates generally to Personal Fall Arrest systems (PFAS), and more particularly to anchorage systems to be used in conjunction with Self Retracting Lifelines (SRL) and harnesses.

2. Description of the Related Art

The perils of working on rooftops are well documented. Due to the slope of the roof and the height of the building, a simple stumble can result in a crippling injury or even death. For this reason, safety regulations typically require that roofing workers utilize one of various prescribed safety devices.

In general, however, roofers work without the benefit of any form of safety device. Although there are a number of reasons for this, two of the primary reasons are the cost and inconvenience of utilizing the safety devices heretofore available. Safety nets, for example, are difficult to set up and must be moved repeatedly as the workers cover the various sections of the roof. Safety rails suffer from similar shortcomings.

In an effort to provide a relatively inexpensive safety device which can be quickly and easily installed, a safety device has been developed which incorporates an support assembly and a spring-loaded spool and cable safety block secured to the top thereof. The fixed end of the cable is secured to a spring-loaded spool within the block's outer housing. The free end of the cable is attached to a ring which is secured to a belt or harness, adapted to be worn by the worker. As the worker walks away from the support assembly, tension on the cable will exceed the force of the spring, thereby unwinding the spool. When the worker approaches the support assembly, tension on the cable will be less than the force exerted by the spring, and the spring will cause the spool to rotate, winding the cable inwardly until the tension on the cable is equal to the force of the spring. If the rate at which the cable unwinds from the spool exceeds a certain rate, corresponding to the early stages of a fall, a brake mechanism will engage, thereby preventing additional cable from unspooling and halting the movement of the worker away from the support.

The support assembly of this safety device is formed by a central shaft and a pair of bracing arms. The lower end of the central shaft and each of the bracing arms is rotatably secured to a flat rectangular foot, rotatable about a horizontal axis, perpendicular to the axis of the support. The feet are adapted to be affixed to the framework of the roof, so as to secure the safety device thereto.

### SUMMARY OF THE INVENTION

Unfortunately, however, use of this safety device has a number of significant drawbacks. The safety device is long and heavy, making it difficult to transport and use for some workers. In some cases, the safety device can be about eight to ten feet tall and can weigh about 200 lbs. The safety device must be transported from jobsite to jobsite. The safety device, when assembled, is too large to be carried in smaller trucks that are commonly used by some workers. Additionally, the safety device, when assembled, is too heavy and cumbersome to be transported by some workers. In some cases, the safety device must be completely disassembled for transportation, which can be time consuming and can decrease worker productivity. Workers are less likely to use a safety device if each time it is transported from job site to job site it must be completely disassembled. Additionally, the safety device is transported from the ground to the roof. The size and weight of the safety device, when assembled, make it difficult to lift or carry the device to the roof. In some cases, the safety device cannot be transported to the roof with out completely disassembling the parts. Additionally, even when the safety device is completely disassembled, it can be time consuming to transport the many parts to the roof. This is especially true when the workers are climbing ladders to get on the roof. The safety device is also transported across at least a portion of the roof. Transporting the assembled safety device on the roof, especially a sloped roof, can be difficult for the workers. Additionally, assembling the safety device on the roof can also be challenging because the length of the central shaft.

The safety device can be difficult to assemble, position, and/or secure on the roof. The central shaft of the support assembly is relatively long compared with the relatively shorter bracing arms. The long central shaft holds the spring-loaded spool and cable safety block well above the surface of the roof. Additionally, the long central shaft is designed to be sturdy enough to support the load of one or more falling workers. Thus, the long central shaft is typically heavier than other components of the safety device. For some workers, the long central shaft can be cumbersome and unwieldy. Transporting the long central shaft to and from the roof, or from one roof location to another roof location, can be difficult or inconvenient for some workers. This is especially true if workers attempt to move the support assembly while the bracing arms are coupled to the long central shaft. Additionally, some workers may have difficulty assembling and securing the support assembly to the roof due to the configuration of the long central shaft.

Accordingly, there is a need in the art for a roofing safety system which can be used on a wide variety of roof configurations, which is tall and strong during use, which is can be broken down into separate pieces, which will be both quick and easy to handle, transport, and install, which will be comfortable for the worker, and which will protect workers in the event of a fall while maximizing the productivity of all workers.

In an effort to provide a relatively inexpensive Personal Fall Arrest system (PFAS) which can be quickly and easily installed, in one embodiment, a PFAS has been developed which incorporates an anchorage assembly, connectors, self retracting lifelines and full body harnesses. The Self Retracting Lifeline is attached to one of a pair of rotating radially extended arms of the of the safety device with a connector. The free end of the cable is attached to one of the D-rings which is secured to the full body harness, adapted to be worn by the worker. As the worker walks away from the anchorage assembly, tension on the cable will exceed the force of the spring, thereby unwinding the Self Retracting Lifeline. When the worker approaches the anchorage assembly, tension on the cable will be less than the force exerted by the spring, and the spring will cause the spool to rotate, winding the cable inwardly until the tension on the cable is equal to the force of the spring. If the rate at which the cable unwinds from the spool exceeds a certain rate, corresponding to the early stages of a fall, a brake mechanism will engage, thereby preventing additional cable from unspooling and halting the movement of the worker away from the support.

In one embodiment, the anchorage assembly includes a vertical central support with a rectangular foot supported by three stabilizing struts with rectangular feet. The vertical central support provides a fixed platform for a pair of rotating radially extended arms for which to attach up to four Self Retracting Lifelines. The device is attached to the roof substrate with eight ⅜″×3″ lag bolts. The lag bolts are inserted through the holes in the rectangular feet of the central support and the three support struts into the wood rafters below the plywood substrate of the roof.

According to one embodiment, a roofing safety system comprises a support assembly adapted to be secured to the roof of a building. The support assembly comprises a central anchor shaft having an upper portion and a lower portion. The support assembly comprises a plurality of struts, each strut having an upper portion and a lower portion, the upper portions of the struts configured to be pivotally coupled to the upper portion of the central anchor shaft. The support assembly comprises a central extension shaft having an upper portion and a lower portion, the lower portion of the central extension shaft configured to be coupled to the upper portion of the central anchor shaft. The support assembly comprises at least one extension arm configured to be rotatably coupled to the upper portion of the extension shaft. The roofing safety system comprises at least one self-retracting lifeline configured to be coupled to the extension arm of the support assembly. The roofing safety system comprises at least one worker restraint configured to be coupled to the self-retracting lifeline.

In another application, a method of providing a roofing safety system comprises providing a support assembly for a roofing safety system having a central anchor shaft, a plurality of struts, a central extension shaft, and at least one extension arm. The plurality of struts and the central anchor shaft are positioned on a roof surface. A foot coupled with the central anchor shaft is secured to the roof surface. A plurality of rotatable feet coupled with the plurality of struts are secured to the roof surface, or to an adjacent surface. The feet are rotatable about non-parallel axes. A lower portion of the central extension shaft is coupled to an upper portion of the central anchor shaft to support the extension arm above the roof surface to receive a self-retracting lifeline.

In another application, a method of providing a roofing safety system comprises providing an anchor assembly for a roofing safety system having a central anchor shaft and a plurality of struts. An extension assembly for a roofing safety system is provided having a central extension shaft and at least one extension arm. The anchor assembly is secured to a roof surface. The extension assembly is secured to the anchor assembly.

Multiple features, aspects and advantages of roofing safety systems are provided in the various embodiments. Advantages of some of the embodiments include use on a wide variety of roof configurations, adjustable and reusable components, quick and easy installation, increased comfort and convenience for workers, establishment of a safe roof area, increased strength and stability of the support assembly, increased safety for workers located on the roof, and increased efficiency and productivity of workers.

### BRIEF DESCRIPTION OF THE DRAWINGS

These and other features of the invention will now be described with reference to drawings of a preferred embodiment which is intended to illustrate, and not to limit, the invention, and in which:

FIG. 1 is a perspective view illustrating a roofing safety system in accordance with one embodiment of the present invention;

FIG. 2 is a perspective view of a support assembly of the roofing safety system illustrated in FIG. 1;

FIG. 3 is a perspective view of a central anchor shaft uncoupled from a central extension shaft of the support assembly of the roofing safety system of FIG. 2;

FIG. 4 is an enlarged perspective view illustrating the attachment of the central anchor shaft to the central extension shaft of the support assembly including a quick release lock of the support assembly of FIG. 2;

FIG. 5 is an enlarged cross-sectional view illustrating the attachment of the central anchor shaft to the central extension shaft of the support assembly including a quick release lock of the support assembly of FIG. 2;

FIG. 6 is an enlarged perspective view illustrating the attachment of a plurality of struts to the central anchor shaft of the support assembly of FIG. 2;

FIG. 7 is an enlarged perspective view of a worker restraint of the roofing safety system of FIG. 1.

FIG. 8 is an enlarged perspective view of another worker restraint for the roofing safety system of FIG. 1.

FIG. 9 is an enlarged partial perspective view illustrating a knuckle joint pivot of the struts of the support assembly of FIG. 2; and

FIG. 10 is a perspective view illustrating the use of the support assembly of FIG. 2 on an irregular rooftop.

### DETAILED DESCRIPTION OF THE PREFERRED EMBODIMENT

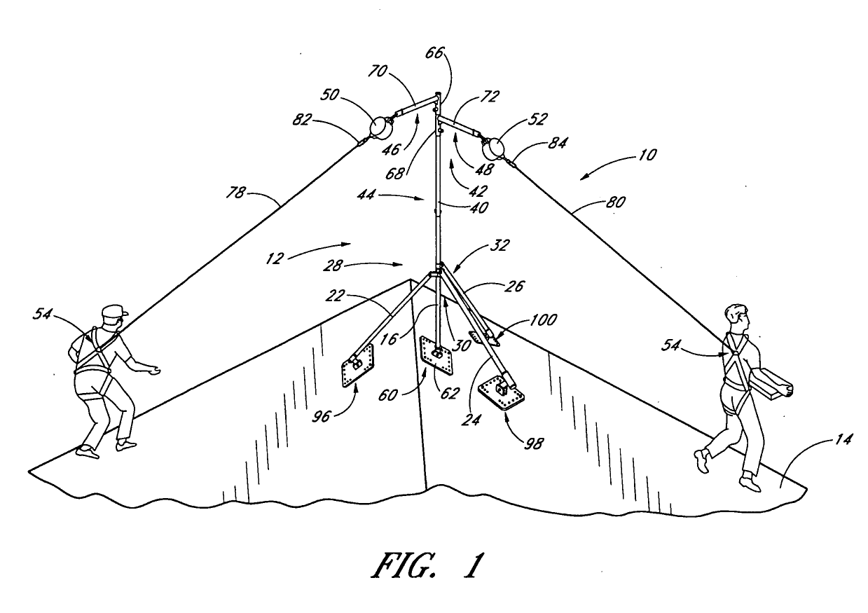

Referring now to the drawings in detail, wherein like reference numerals designate like elements throughout the several views thereof, there is shown generally at 10 a roofing safety system embodying the present invention in a preferred form. As illustrated in FIG. 1, in one embodiment, the roofing safety system 10 comprises a support assembly 12 adapted to be secured to the roof 14 of a building. The support assembly 12 comprises a central anchor shaft 16 having an upper portion 18 and a lower portion 20. The support assembly 12 comprises a plurality of struts 22, 24, 26, each strut having an upper portion 28, 30, 32 and a lower portion 34, 36, 38. The upper portions 28, 30, 32 of the struts 22, 24, 26 are configured to be pivotally coupled to the upper portion 18 of the central anchor shaft 16. The support assembly 12 comprises a central extension shaft 40 having an upper portion 42 and a lower portion 44. The lower portion 44 of the central extension shaft 40 is configured to be coupled to the upper portion 18 of the central anchor shaft 16. The support assembly 12 comprises at least one extension arm 46, 48 configured to be rotatably coupled to the upper portion 42 of the extension shaft 40. At least one self-retracting lifeline 50, 52 is configured to be coupled to the extension arm 46, 48 of the support assembly 12. At least one worker restraint 54 is configured to be coupled to the self-retracting lifeline 50, 52. When the worker restraint 54 is worn by a worker and connected to the roofing safety system 10, the chances of the worker suffering a crippling fall or, more drastically, falling to his death are dramatically reduced.

As described further below, in one embodiment, the upper portion 18 of the central anchor shaft 16 is configured to be locked with the lower portion 44 of the central extension shaft 40. The upper portion 18 of the central anchor shaft 16 preferably is coupled with the lower portion 44 of the central extension shaft 40 through a quick release lock, e.g., by a clevis pin 56 and a locking clip 58. In one embodiment, no tools are required to couple the central anchor shaft 16 with the central extension shaft 40. The quick release lock preferably locks the central anchor shaft 16 to the central extension shaft 40 so that they will not become disengaged accidentally during use. Unlike screws, and nuts and bolts, which can loosen over time due to vibration or other factors, the clevis pin 56 and locking clip 58 provide a simple and reliable connection that is easy to use. Additionally, the clevis pin 56 and locking clip 58 are superior to threaded shaft portions that screw into one another. Threaded shaft portions can loosen as workers move around the shafts on the roof, if the shafts are not otherwise coupled together with a locking coupling. Furthermore, the quick release lock, e.g., the clevis pin 56 and the locking clip 58, provides for quick visual verification that the lock is secure. Advantageously, a worker can see from a distance that the clevis pin 56 and locking clip 58 are in place and can be assured that the central anchor shaft 16 and the central extension shaft 40 are firmly coupled. Any inconvenience for the purpose of utilizing a safety device is only likely to be endured if the workers believe that if the safety device is utilized, it will properly perform its function. The gap between life and death is the ease of use of the safety device.

Additionally, being able to quickly and easily couple and uncouple the central anchor shaft 16 and the central extension shaft 40 using the quick release lock allows workers to separate portions of the support assembly 12 without completely disassembling the support assembly 12. For example, the struts 22, 24, 26 can remain attached to the central anchor shaft 16 and the extension arms 46, 48 can remain attached to the central extension shaft 40, when the shafts 16, 40 are uncoupled. Being able to uncouple the shafts 16, 40 allows the workers to more easily transport the two portions of the support assembly 12 between job sites, from the ground to a roof, and across a roof surface. The two portions of the support assembly 12 are much easier to handle than the longer and heavier safety devices. Additionally, despite expectations to the contrary, using a combination of a central anchor shaft 16 and a central extension shaft 40, rather than a single long shaft, provides sufficient strength and support for workers while reducing the difficulties associated with safety devices having a long shaft. Thus, the support assembly 12 overcomes many of the inconveniences and concerns associated with the use of other safety devices.

In one embodiment, the upper portion 18 of the central anchor shaft 16 preferably receives part of the lower portion 44 of the central extension shaft 40 such that the central anchor shaft 16 and the central extension shaft 40 overlap by at least about 5 inches, and preferably by about 7 inches or more. In another embodiment, the upper portion 18 of the central anchor shaft 16 extends into the lower portion 46 of the central extension shaft 40 such that the central anchor shaft 16 and the central extension shaft 40 overlap by at least about 5 inches, and preferably by about 7 inches or more.

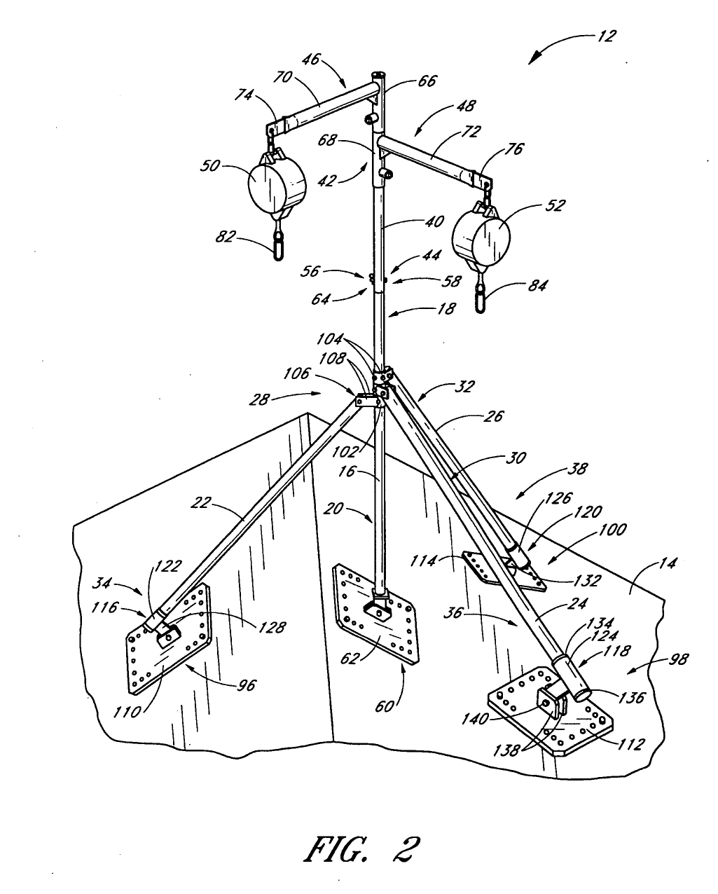

As shown in FIG. 2, the support assembly 12 includes the central anchor shaft 16. The central anchor shaft 16 is maintained in an upright position by braces and/or stabilizing struts 22, 24, 26, as will be discussed in greater detail below. The central anchor shaft 16 preferably extends vertically when attached to the roof 14. The central anchor shaft 16 preferably is centrally arranged relative to the struts 22, 24, 26 that support the central anchor shaft 16 in the vertical position. A foot 60 is coupled with the lower portion 20 of the central anchor shaft 16 for attaching the central anchor shaft 16 to the roof 14. In one embodiment, the foot 60 preferably has a flat and rectangular base 62.

The central anchor shaft 16 can be any suitable size and comprise any suitable material. In some embodiments, significant advantages are achieved using the sizes and materials disclosed herein. The central anchor shaft 16 preferably is sufficiently strong to resist bending or breaking under the load of a fallen worker attached to the worker restraint 54. A large bending moment can be created when a falling worker is stopped by the roofing safety system. The amount of torque generated by a falling worker can be up to about 1000 foot pounds, or more, in some cases. When the self-retracting lifeline 50, 52 automatically locks the cable of the falling worker, the force of the falling worker tends to jerk the central anchor shaft 16. The central anchor shaft 16 preferably is made of a rigid material, such as, for example, steel. In some embodiments, the central anchor shaft 16 preferably comprises a 2½ inch schedule 40 pipe. The central anchor shaft 16 can have an outer diameter of about 3 inches, and a wall thickness of about 0.2 inches. In one embodiment, the weight per foot in pounds for the central anchor shaft 16 is about 5.8 pounds. In some embodiments, the central anchor shaft 16 can be between about 30 inches and about 60 inches tall. Preferably, the central anchor shaft 16 is between about 40 inches and about 50 inches tall. The central anchor shaft 16 preferably is of such a height that it is easily handled, transported, and installed on a rooftop 14.

The foot 60 of the central anchor shaft 16 can be any suitable size and comprise any suitable material. In some embodiments, significant advantages are achieved using the sizes and materials disclosed herein. In some embodiments, the base 62 of the foot 60 can be about ⅛ inch thick or more. Preferably, the base 62 of the foot 60 is about ¼ inch thick or more. The foot 60 preferably is made of a rigid material, such as, for example, steel. Steel has significant strength and can be configured for easy attachment to the roof 14.

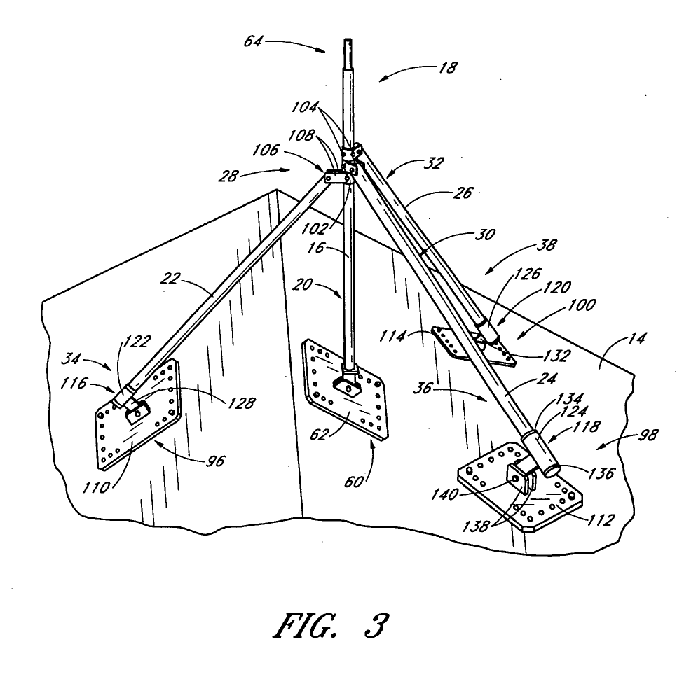

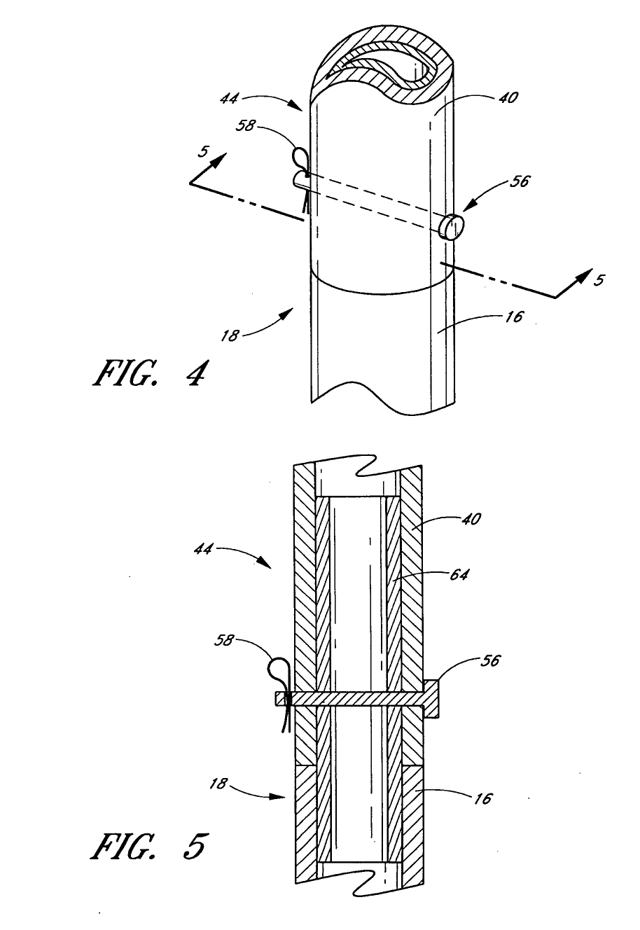

The central anchor shaft 16 preferably comprises a central extension shaft retaining portion 64, as shown in FIGS. 2-5. The central extension shaft retaining portion 64 is configured to receive and support at least a portion of the central extension shaft 40 extending from the central anchor shaft 16. As shown in FIGS. 2-5, in one embodiment, the central extension shaft retaining portion 64 is positioned at an upper portion 18 of the central anchor shaft 16. The upper portion 18 can be any suitable size or configuration for coupling with the central extension shaft 40. In the illustrated embodiment, the upper portion 18 is sized and configured to extend into the lower portion 44 of the central extension shaft 40. Accordingly, the central anchor shaft 16 is easily and quickly attachable to, and detachable from, the central extension shaft 40. An opening in the bottom of the central extension shaft 40 can be easily positioned over the top of the central anchor shaft 16. The central extension shaft 40 can be slid into place over the central extension shaft retaining portion 64. The central extension shaft retaining portion 64 advantageously functions as a guide for the central extension shaft 40. The overlap between central anchor shaft 16 and the central extension shaft 40 acts to reinforce the connection between the shafts 16, 40. In another embodiment, the upper portion 18 of the central anchor shaft 16 is sized and configured to receive and surround at least a portion of the lower portion 44 of the central extension shaft 40.

The clearance between the central anchor shaft 16 and the central extension shaft 40 preferably is sufficient to allow the shafts 16, 40 to slide relative one another, but also to be held firmly together when coupled. In some embodiments, the clearance between the central anchor shaft 16 and the central extension shaft 40 preferably is about 1/16 of an inch. In another embodiment, the clearance between the central anchor shaft 16 and the central extension shaft 40 preferably is about ⅛ of an inch. Advantageously, positioning the central extension shaft 40 over the central anchor shaft 16 with sufficient clearance to allow for sliding, but without introducing excess play between the shafts 16, 40, allows the shafts 16, 40 to be easily and quickly attached or detached from one another, while maintaining sufficient rigidity and structure to support a worker in the event of a fall.

In some embodiments, the central extension shaft 40 overlaps with the central anchor shaft 16 by at least about 5 inches, and preferably by about 7 inches or more. In some embodiments, the central extension shaft 40 overlaps with the central anchor shaft 16 by at least about 5 inches, and preferably by about 7 inches or more. In some embodiments, the connection between the central extension shaft 40 and the central anchor shaft 16 provides sufficient strength to avoid breaking or disconnecting in the event that a worker falls and places strain on the support assembly. In some embodiments, the central anchor shaft 16 comprises a coupling shaft as retaining portion 64, positioned at least partially within, and welded to, the upper portion 18 of the central anchor shaft 16. The coupling shaft preferably extends into the lower portion 44 of the central extension shaft 40 and can be coupled therewith by the clevis pin 56 and locking clip 58. In another embodiment, the central anchor shaft 16 can receive a coupling shaft welded to the central extension shaft 40.

The central extension shaft 40 can be any suitable size and comprise any suitable material. In some embodiments, significant advantages are achieved using the sizes and materials disclosed herein. The central extension shaft 40 preferably is sufficiently strong to resist bending or breaking under the load of a fallen worker attached to the worker restraint 54. In some embodiments, the central extension shaft 40 can be between about 10 inches and about 50 inches tall. Preferably, the central extension shaft 40 is between about 20 inches and about 40 inches tall. The central extension shaft 40 preferably is of such a height that it is easily handled, transported, and installed on a roof 14. The central extension shaft 40 preferably is made of a rigid material, such as, for example, steel. In some embodiments, the central extension shaft 40 preferably comprises a 2½ inch schedule 40 pipe. The central extension shaft 40 can have an outer diameter of about 3 inches, and a wall thickness of about 0.2 inches. In one embodiment, the weight per foot in pounds for the central extension shaft 40 is about 5.8 pounds.

The lower portion 44 of the central extension shaft 40 is configured to be coupled with the upper portion 18 of the central anchor shaft 16. In the illustrated embodiment, the upper portion 18 of the central anchor shaft 16 comprises a coupling shaft, and the central extension shaft 40 can receive the coupling shaft. In some other embodiments, the lower portion 44 of the central extension shaft 40 comprises a coupling shaft, which extends into the upper portion 18 of the central anchor shaft 16 and can be coupled therewith by the clevis pin 56 and the locking clip 58.

The upper portion 42 of the central extension shaft 40 is configured to be coupled with one or more extension arms 46, 48. In one embodiment, the central extension shaft 40 provides a fixed platform about which a pair of radially extending arms 46, 48 are rotatable. Each arm 46, 48 preferably includes a vertically extending tubular sleeve portion 66, 68 and a radially extending arm portion 70, 72, respectively. The inner diameter of the sleeve portion 66, 68 is slightly larger than the outer diameter of the central extension shaft 40, so as to allow free rotation of the arms 46, 48 about the central extension shaft 40, without significant lateral movement.

A safety mechanism preferably is configured to be coupled to the extension arm 46, 48 of the support assembly 12. In one embodiment, a self-retracting lifeline 50, 52 is secured to an outer portion 74, 76 of each radially extending arm 46, 48. The self-retracting lifeline 50, 52 includes a cable 78, 80 which is secured to a spring-loaded spool. The spring-loaded spool permits the cable 78, 80 to be unwound in response to forces sufficient to overcome the bias of the spring. When the force of the cable 78, 80 is less than the force of the spring, the spool rotates, so as to rewind the cable 78, 80, thereby preventing significant slack from forming in the cable. The self-retracting lifeline 50, 52 further includes a self-breaking mechanism, which stops the rotation of the spool if the rate of release of the cable 78, 80 exceeds a certain rate of feet per second, corresponding to the early stages of a fall.

In one embodiment, a worker restraint is configured to be coupled to the safety mechanism. As shown in FIGS. 1, 2, 6 and 7, the self-retracting lifeline 50, 52 comprises a fastening mechanism 82, 84 disposed at the free end of the cable 78, 80. In one embodiment, the fastening mechanism 82, 84 is adapted to clip onto the worker restraint 54. The worker restraint 54 can comprise rings 86 disposed at spaced intervals on the outer layer of the worker restraint 54 to permit the worker to secure the cable 78, 80 to either side of his body, enabling the worker to use the roofing safety system 10 without it rubbing against his body.

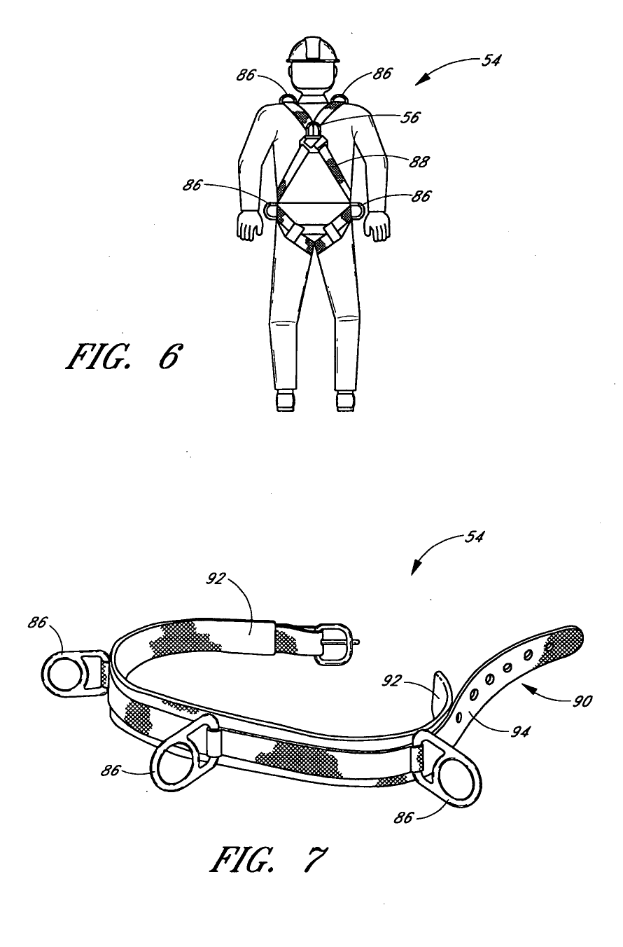

As shown in FIGS. 1, 6, and 7, the worker restraint 54 is configured to be coupled with the cable 78, 80 of the self-retracting lifeline 50, 52. In some embodiment, the worker restraint 54 comprises a harness 88, as shown in FIG. 6, or a belt 90, as shown in FIG. 7, securable to the body of a worker on the roof 14 and a means for attaching the cable 78, 80 to the harness 88 or belt 90 at one or more locations. The harness 88 and belt 90 preferably comprise one or more rings 86 for securing the cable 78, 80 to the harness 88 or belt 90.

An exemplary harness 88 is illustrated in FIG. 6. The harness 88 preferably is a fall-arrest harness. As shown, the harness 88 has a D-ring attachment point at the rear between the shoulder blades of the worker. This type of harness is useful where the anchor position is located behind the worker. The harness 88 preferably can be adjusted with two or more buckles. The harness 88 can also comprise an adjustable chest strap (not shown). Other fastening rings 86 can be used.

An exemplary belt 90 of the roofing safety system 10 is illustrated in FIG. 7. The use of a plurality of rings 86, disposed at spaced intervals on the belt 90 permits the worker to secure the cable 78, 80 to various sides of the worker's body. The worker can thus perform tasks on the roof 14 without being chafed by the cable 78, 80. The belt 90 preferably is double layered, having an interior layer 92 which is cushioned to promote the comfort of the wearer, and an outer heavy layer 94 to enhance the strength of the belt 90. Preferably, three heavy rings 86 are firmly secured to the outer layer 94 of the belt 90 at spaced intervals, corresponding to the hips of the wearer and the small of the wearer's back. It would be possible, of course, to utilize a belt 90 with a single ring to slide about the wearer to permit the worker to utilize the belt 90 without being chafed by the cable 78, 80. Experience has shown that unless the roofing safety system 10 is comfortable and convenient for the worker, it will generally not be used by the worker.

As stated above, and shown in FIG. 2, a plurality of braces and/or stabilizing struts 22, 24, 26 support the central anchor shaft 16. The struts 22, 24, 26 preferably are sufficiently strong to resist bending or breaking under the load of a fallen worker attached to the worker restraint 54. In one embodiment, the struts 22, 24, 26 are provided with feet 96, 98 100, respectively, which are described in more detail below. In some embodiments, one or more of the feet 96, 98 100, are rotatable about an axis perpendicular to the axes of the struts 22, 24, 26, respectively. In some embodiments, one or more of the feet 96, 98 100, are rotatable about a pair of orthogonal axes. In some embodiments, the ability of the feet 96, 98 100, of the struts 22, 24, 26 to rotate about orthogonal axes permits the roofing safety system 10 to be used in connection with the wide variety of varying roof pitches and stepped roofs which confront the roofer in today's construction environment.

The struts 22, 24, 26 can be any suitable size and comprise any suitable material. In some embodiments, significant advantages are achieved using the sizes and materials disclosed herein. In some embodiments, the struts 22, 24, 26 can be between about 20 inches and about 60 inches long. Preferably, the struts 22, 24, 26 are between about 30 inches and about 50 inches long. The struts 22, 24, 26 preferably are long enough to adequately brace and support the central anchor shaft 16 on the roof 14. The struts 22, 24, 26 preferably are made of a rigid material, such as, for example, steel. In some embodiments, the struts 22, 24, 26 preferably comprise 1½ inch schedule 40 pipe. The struts 22, 24, 26 can have an outer diameter of about 1.9 inches, and a wall thickness of about 0.15 inches. In one embodiment, the weight per foot in pounds for the struts 22, 24, 26 is about 2.7 pounds.

Each strut 22, 24, 26 has an upper portion 28, 30, 32 and a lower portion 34, 36, 38. The upper portions 28, 30, 32 are coupled with the central anchor shaft 16. The struts 22, 24, 26 preferably are adjustably coupled with the central anchor shaft 16 through a collar 102 having a lock bolt 104 and a pivot bolt 106. As best illustrated by FIG. 7, each of the struts 22, 24, 26 is secured to the central anchor shaft 16 in the same manner. The cylindrical collar 102 has a pair of radially extending spacer plates 108 and is rotatably secured to the central anchor shaft 16 by a plurality of lock bolts 104 or set screws. The upper portions 28, 30, 32 of the struts 22, 24, 26 are secured between the spacer plates 108 by means of a pivot bolt 106 or pin having an axis perpendicular to that of the spacer plates 108. Thus, the struts 22, 24, 26 can rotate about the central anchor shaft 16 when the lock bolts 106 or set screws are loosened, and may also pivot about the pivot bolt 106 or pin. Some examples of coupling mechanisms are disclosed in U.S. Pat. Nos. 4,942,943 and 4,852,692, which are hereby incorporated by reference herein in their entirety.

As shown in FIGS. 1-3 and 9, a plurality of feet 96, 98, 100 are coupled with the struts 22, 24, 26 at their lower portions 34, 36, 38. The feet 96, 98, 100 preferably have flat and rectangular bases 110, 112, 114. The feet 96, 98, 100 preferably are attachable to the roof 14 or an adjacent surface. The feet 96, 98, 100 preferably are aligned with, and coupled to, the rafters or other support structure of the roof 14 when in use. The feet 96, 98, 100 of the struts 22, 24, 26 can be any suitable size and comprise any suitable material. In some embodiments, the bases 110, 112, 114 of the feet 96, 98, 100 can be about ⅛ inch to about ½ inch thick, or more. Preferably, the bases 110, 112, 114 of the feet 96, 98, 100 are about ¼ inch thick, or more. The feet 96, 98, 100 preferably are made of a rigid material, such as, for example, steel.

Preferably, one or more of the feet 96, 98, 100 are rotatable about non-parallel axes. With reference to FIGS. 1-3 and 9-10, the use of struts 22, 24, 26 having feet 96, 98, 100 with the ability to rotate about a pair of orthogonal axes permits the roofing safety system 10 to be used on a stepped roof. An L-shaped spacer 116, 118, 120 is coupled with the lower portion 34, 36, 38 of one or more of the struts 22, 24, 26. The L-shaped spacer 116, 118, 120 comprises a cylindrical sleeve portion 122, 124, 126 and a tongue portion 128, 130, 132.

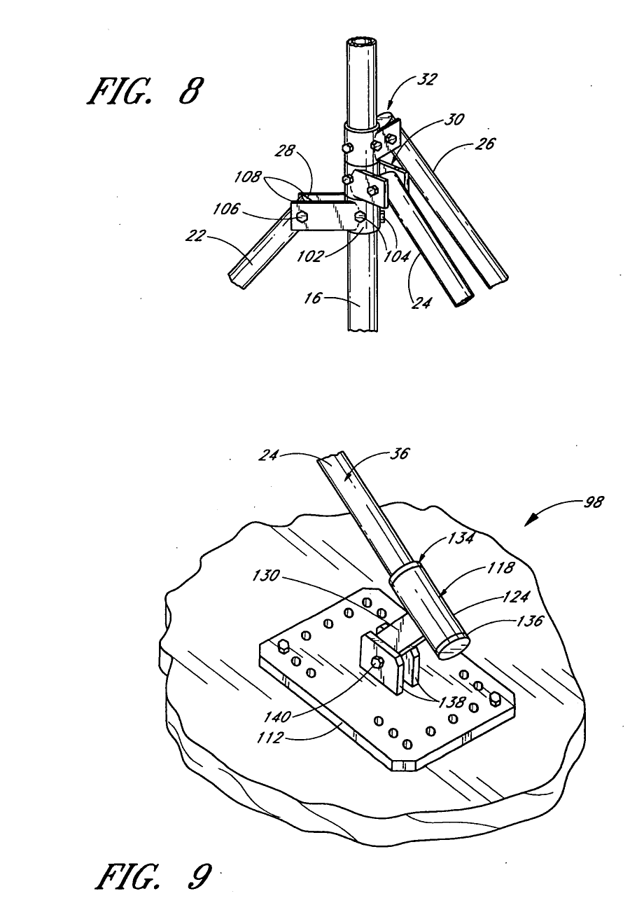

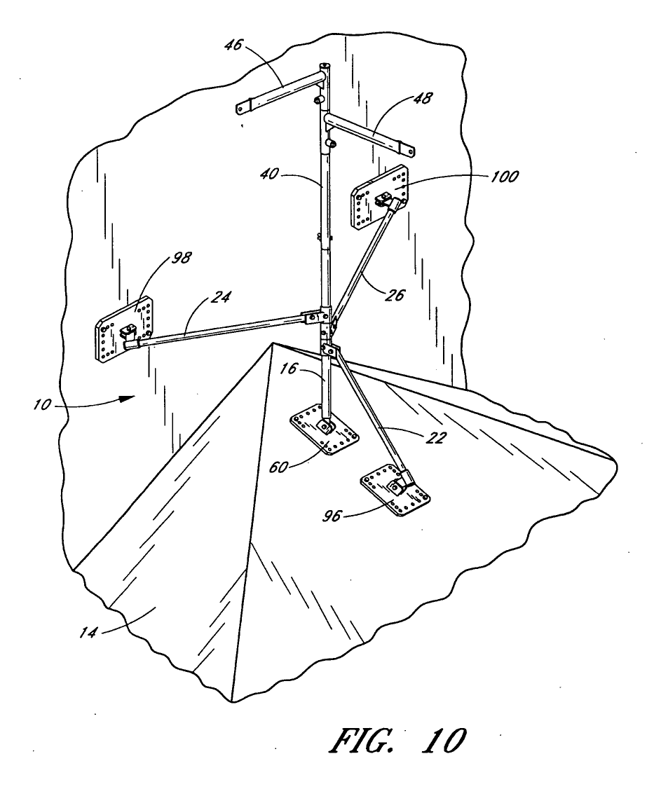

As shown in FIG. 9, the sleeve portion 124 is rotatable about the strut 26. The sleeve portion 124 has an inner diameter slightly larger than the outer diameter of the strut 26, thereby permitting the free rotation of the spacer 118 about the strut 26 without significant lateral movement. The sleeve portion 124 is prevented from moving axially along the strut 26 by two raised cylindrical rings 134, 136 fixed to the strut 26 axially adjacent either end of the sleeve portion 124 of the spacer 118.

The tongue portion 130 extends radially outward from the sleeve portion 124. The tongue portion 130 is secured between a pair of raised plates 138 extending perpendicularly upward from the base 112 of the foot 98 with a pivot bolt 140 or pin. The tongue portion 130 allows the foot 98 to rotate about an axis perpendicular to the axis of the strut 26.

FIG. 10 illustrates the ability of one embodiment of the roofing safety system 10 to be used in connection with an irregular rooftop. The foot 60 of the central anchor shaft 16 is aligned with a surface of the roof 14, preferably over a support beam. The strut 22 is then secured to the roof 14 in a similar manner. Because the feet 98, 100 of the struts 24, 26 are rotatable about a pair of orthogonal axes, it is possible to position the struts 24, 26 in a number of various configurations. As depicted in FIG. 10, the struts 24, 26 may be secured to a wall or even to exceptionally steep rooftops. The enhanced ability of the roofing safety system 10 to conform to substantially any roofing configuration strongly increases the likelihood that use of the roofing safety system 10 of the present invention will become habitual so as to reduce the number of roofing injuries and deaths.

With reference to FIG. 2, according to one technique, a method of providing a roofing safety system 10 comprises securing one or more support assemblies 12 on at least a portion of a roof 14. A support assembly 12 preferably is positioned along a ridge portion of the roof 14 at least about six feet from an edge of the roof and/or another support assembly. The support assembly 12 can be located any suitable distance from an edge of the roof and/or another support assembly. In some embodiments, a support assembly 12 can be located between about 6 feet and about 10 feet from an edge of the roof and/or another support assembly. Moving the support assembly 12 further from the edge of the roof maximizes the safe work area on the roof.

Securing one or more support assemblies 12 along at least a portion of the roof 14 can include aligning the foot 60 of the central anchor shaft 16 with a surface of the roof 14. The foot 60 of the central anchor shaft 16 is secured to the surface of the roof 14. The foot 60 preferably is secured to a support beam of the roof, e.g., a rafter. One or more feet 96, 98, 100 of the one or more struts 22, 24, 26 coupled with the central anchor shaft 16 are secured to the surface of the roof 14 or to an adjacent surface. The feet 96, 98, 100 preferably are secured to support beams in the roof 14 or in the adjacent surface. The feet 96, 98, 100 of the struts 22, 24, 26 preferably are rotatable about non-parallel axes. In some embodiments, at least one of the feet 96, 98 100, of the struts 22, 24, 26 attached to the central anchor shaft 16 is secured to a substantially vertical wall.

The method of providing a roofing safety system 10 may additionally comprise coupling the central extension shaft 40 with the central anchor shaft 16 such that the central extension shaft 40 extends above a surface of the roof 14. In some embodiments, the central extension shaft 40 can be inserted into or fitted over the central anchor shaft 16. In one embodiment, the central extension shaft 40 and central anchor shaft 16 are positioned such that they overlap by more than about 5 inches, and preferably by about 7 inches or more. In one technique, the central extension shaft 40 is locked to the central anchor shaft 16 with a clevis pin 56 and locking clip 58.

According to one technique, the method of providing a roofing safety system 10 may additionally comprise coupling at least one extension arm 46, 48 to the central extension shaft 40. One or more self-retracting lifelines 50, 52 preferably are coupled with the extension arm 46, 48. One or more worker restraints 154 can be coupled to the self-retracting lifelines 50, 52. Workers can wear the worker restraints 54 while working on the roof 14.

The safety system 10 may be used on many types of roofs as a temporary safety system to protect workers on the roof. One particular use is associated with peaked roofs. Another use can be with generally flat, commercial roofs that do not have a wall along the edge of the roof. The safety system 10 can be easily handled, transported and assembled on a variety of rooftops. The length and configuration of the central anchor shaft 16 and the central extension shaft 40 are specially adapted for the convenience and safety of the worker. A worker can wear a harness 80 or belt 90 of a worker restraint 54 that can be coupled to the cable 14. The worker can walk along the roof 14 and if the worker should fall from the roof, the safety system 10 can support the worker until the worker can be assisted.

The roofing safety system 10 is adjustable and can be fastened to a variety of roof configurations. Additionally the support assembly 12, including the central anchor shaft 16 and the central extension shaft 40, is easy to handle and transport on a roof 14. The support assembly 12 is also quick and easy to set up and is reusable. Because the roofing safety system 10 can be used on many types of roofs and is easy to use, it is more likely that workers will get into the habit of using the system, thereby increasing worker safety. Additionally, the quick set up saves money and time usually associated with providing a safety system.

Accordingly, advantages of some of the embodiments of the roofing safety system include use on a wide variety of roof configurations, adjustable and reusable components, quick and easy handling, transporting, and installation, increased comfort and convenience for workers, establishment of a safe roof working area, increased safety for workers, and increased efficiency and productivity of workers.

It will be appreciated that certain structural variations may suggest themselves to those skilled in the art. The foregoing detailed description is to be clearly understood as given by way of illustration, the spirit and scope of this invention being limited solely by the appended claims.

What is claimed is:

1. A roofing safety system, comprising:
a support assembly adapted to be secured to the roof of a building, the support assembly comprising
a central anchor shaft having an upper portion and a lower portion,
a plurality of struts, each strut having an upper portion and a lower portion, the upper portions of the struts configured to be pivotally coupled to the upper portion of the central anchor shaft,
a central extension shaft having an upper portion and a lower portion, the lower portion of the central extension shaft configured to be coupled to the upper portion of the central anchor shaft, and
at least one extension arm configured to be rotatably coupled to the upper portion of the extension shaft,
at least one self-retracting lifeline configured to be coupled to the extension arm of the support assembly, and
at least one worker restraint configured to be coupled to the self-retracting lifeline.

2. The system of claim 1, wherein the upper portion of the central anchor shaft is configured to be locked with the lower portion of the central extension shaft.

3. The system of claim 1, wherein the upper portion of the central anchor shaft is coupled with the lower portion of the central extension shaft by a quick-release lock.

4. The system of claim 1, wherein the upper portion of the central anchor shaft is configured to be coupled with the lower portion of the central extension shaft through a clevis pin and a locking clip.

5. The system of claim 1, wherein the upper portion of the central anchor shaft comprises a coupling shaft configured to be coupled with the lower portion of the central extension shaft.

6. The system of claim 1, wherein the upper portion of the central anchor shaft extends into the lower portion of the central extension shaft such that the central anchor shaft and the central extension shaft overlap by at least about five inches.

7. The system of claim 1, wherein the lower portion of the central extension shaft comprises a coupling shaft configured to be coupled with the upper portion of the central anchor shaft.

8. The system of claim 1, wherein the upper portion of the central anchor shaft receives part of the lower portion of the central extension shaft such that the central anchor shaft and the central extension shaft overlap by at least about five inches.

9. The system of claim 1, wherein the upper portion of each of the plurality of struts is configured to be adjustably coupled with the central anchor shaft through a collar having a lock bolt and a pivot bolt.

10. The system of claim 1, wherein the lower portion of the central anchor shaft is configured to be coupled to a foot, the foot is configured to be attached to the roof.

11. The system of claim 1, wherein the worker restraint is a harness.

12. The system of claim 1, wherein the lower portion of each of the plurality of struts is configured to be pivotally coupled to a foot, the foot is rotatable about non-parallel axes and configured to be attached to the roof or an adjacent surface.

13. The system of claim 12, wherein the lower portion of each of the plurality of struts is configured to be pivotally coupled with the foot through an L-shaped spacer, the L-shaped spacer comprises a cylindrical sleeve portion and a tongue portion, the cylindrical sleeve portion is rotatable about the strut, the tongue portion extends radially outwardly from the sleeve portion, the tongue portion is secured between a pair of raised plates extending perpendicularly upward from the foot, whereby the tongue portion allows the foot to rotate about an axis perpendicular to an axis of the strut.

14. The system of claim 12, wherein the foot comprises a generally flat, generally rectangular-shaped base.

15. A method of providing a roofing safety system, comprising:
providing a support assembly for a roofing safety system having a central anchor shaft, a plurality of struts, a central extension shaft, and at least one extension arm,
positioning the plurality of struts and the central anchor shaft on a roof surface;
securing a foot coupled with the central anchor shaft to the roof surface;
securing a plurality of rotatable feet coupled with the plurality of struts to the roof surface or to an adjacent surface, the feet being rotatable about non-parallel axes;
coupling a lower portion of the central extension shaft to an upper portion of the central anchor shaft to support the extension arm above the roof surface to receive a self-retracting lifeline.

16. The method of claim 15, wherein coupling the lower portion of the central extension shaft to the upper portion of the central anchor shaft comprises locking the central extension shaft with the central anchor shaft.

17. The method of claim 15, wherein coupling the lower portion of the central extension shaft to the upper portion of the central anchor shaft comprises coupling a clevis pin and a locking clip with the central extension shaft and the central anchor shaft.

18. The method of claim 15, wherein coupling the lower portion of the central extension shaft to the upper portion of the central anchor shaft comprises placing the upper portion of the central anchor shaft over part of the lower portion of the central extension shaft such that the central anchor shaft and the central extension shaft overlap by at least about five inches.

19. The method of claim 15, wherein coupling the lower portion of the central extension shaft to the upper portion of the central anchor shaft comprises placing the upper portion of the central anchor shaft into part of the lower portion of the central extension shaft such that the central anchor shaft and the central extension shaft overlap by at least about five inches.

20. The method of claim 15, additionally comprising coupling a self-retracting lifeline to the extension arm.

21. The method of claim 20, additionally comprising coupling a worker restraint to the self-retracting lifeline.

22. The method of claim 15, wherein the foot coupled with the central anchor shaft is secured to a roof support beam.

23. The method of claim 15, wherein the plurality of rotatable feet coupled with the plurality of struts are secured to one or more roof support beams.

24. The method of claim 15, wherein at least one of the plurality of rotatable feet coupled with the plurality of struts is secured to a substantially vertical wall.

25. The method of claim 15, wherein the support assembly is positioned along a ridge of the roof.

26. The method of claim 15, wherein the support assembly is positioned more than about six feet from the edge of the roof.

27. A method of providing a roofing safety system, comprising:
providing an anchor assembly for a roofing safety system having a central anchor shaft and a plurality of struts,
providing an extension assembly for a roofing safety system having a central extension shaft and at least one extension arm,
securing the anchor assembly to a roof surface; and
securing the extension assembly to the anchor assembly.

28. The method of claim 27, additionally comprising securing a self-retracting lifeline to the extension assembly.

29. The method of claim 27, wherein securing the extension assembly to the anchor assembly includes coupling the assemblies with a quick release lock.

30. The method of claim 27, additionally comprising transporting the anchor assembly relative to the roof surface independent of the extension assembly.

31. The method of claim 27, additionally comprising transporting the extension assembly relative to the roof surface independent of the anchor assembly.
